(19) United States
(12) Patent Application Publication
(10) Pub. No.: US 2006/0097417 A1
(43) Pub. Date: May 11, 2006

(54) Method and installation for the production of a plastic container

(76) Inventor: Gerard Emmer, Octeville sur Mer (FR)

Correspondence Address: SUGHRUE MION, PLLC, 2100 PENNSYLVANIA AVENUE, N.W., SUITE 800, WASHINGTON, DC, 20037, US

(21) Appl. No.: 10/540,141

(22) PCT Filed: Dec. 17, 2003
(86) PCT No.: PCT/FR03/03758

§ 371 Date: Aug. 9, 2005

(30) Foreign Application Priority Data
Dec. 23, 2002 (FR) 02/16692

(51) Int. Cl. B29C 49/78; B29C 49/64

(52) U.S. Cl. 264/40.1; 264/535; 264/40.3; 264/524; 425/526; 425/535; 425/144; 425/149

(57) ABSTRACT

The invention relates to a method and installation for the production of a plastic container (1). The inventive method comprises: (i) a step involving the thermal conditioning of at least some areas (2) of a preform (3) of the container, such that the temperature of said areas exceeds the glass transition temperature of the constituent material thereof; and (ii) a step involving the injection of a fluid into the preform (3) so as to cause the preform to expand in order to shape same into a container. According to the invention, unrestrained expansion of the above-mentioned areas of the preform is performed, i.e. without a mould, by controlling at least one injection parameter of the fluid in order to obtain the definitive container (1).

A purpose of the invention is to make improvements to the methods and systems of manufacturing containers from plastic material from previously injected preforms that are thermally conditioned then transformed into containers during an expansion produced by injecting a fluid into the preform. It is applicable to the manufacture, at less cost, of containers intended more particularly—although not exclusively—for receiving products (including but not limited to water or other refreshing liquids) that are low in price relative to that of the containers.

For several years the manufacture of plastic containers from previously injected preforms has experienced rapid development, particularly as a result of the use of polyethylene terephtalate (PET). Meanwhile, other materials have been considered and/or used with more or less success, including but not limited to polyethylene naphtalate (PEN), polypropylene (Products) or mixtures or overlays of various materials.

To manufacture a container with such materials, the preform, in the form of a specimen formed in an injection mold, is introduced into a thermal conditioning unit, still called an oven, in which its constituent material is heated to a temperature above its glass transition temperature, but without reaching its crystallization temperature. Upon completion of this thermal conditioning phase, the preform is transferred into a mold pertaining to a blow molding unit. The mold comprises a cavity with an impression of the final container.

When the unit is a blow molding unit, the preform, after having been inserted into the mold, is there injected with a fluid, usually air, at high pressure, typically on the order of 40 bars, to be transformed into the final container. When the unit is a drawing/blow molding one, which is most often the case, the preform, after having been inserted into the mold, is there drawn along its longitudinal axis, generally accompanied by an injection of pre-blowing fluid (at a pressure of around 10 bars) and injection of blow molding fluid. The use of high-pressure blow molding allows the shape and details of the final container to be perfectly controlled, since the material can be forced into the smallest voids of the mold. Finally, the container is either stored empty before being transported to a filling unit, or it is transferred directly along a more or less direct route to a filling unit where it is filled, then closed.

In general, the thermal conditioning unit is arranged so that the neck of the preform is not heated. Indeed, the neck is the part of the preform that corresponds to the neck of the final container. It is therefore produced in its final shape and dimensions during injection of the preform, and should not be deformed in the subsequent phases of blow molding or drawing blow molding. The neck has an opening (the neck per se) and a peripheral area thereof with means (threads, lip, or other) appropriate for receiving the closing part (plug, cap or other) of the final container. Moreover, in most cases it has means, typically a collar, for transporting the preform and the container after it is produced, and/or after it is filled and/or otherwise handled.

Generally, the thermal conditioning unit is constructed to allow differentiated heating of certain areas of the preform, in order to optimize the distribution of the material in the final container. The heating profile of the preform is determined by taking into account the shape and dimensions of the preform, as well as the shape and dimensions of the final container. Thus, for example, the document FR-A-2,703,944 in the name of the applicant reveals a method and device for selective or preferential heating of certain areas of the preform to produce a bottle.

The known devices and methods of manufacturing containers by blow molding or drawing/blow molding have disadvantages.

On the one hand, molds, which comprise important elements for producing the final conformation of the containers and the repeatability of the shapes, are expensive. Indeed, they require delicate machining and finishing (polishing) operations of their cavities. The known machines of the applicant have from two to forty molds, some being single cavity while others are bi-cavity.

The means of compressing the blow molding fluid, in order to achieve the high pressures needed to produce the shape in the cavities, are also expensive elements and become more complex the greater the required flow rate. It should be noted that some machines produce 60,000 containers per hour, which represents a requirement of about 240,000 liters of fluid per hour by the compression means (assuming that the containers, blow molded at 40 bars, have a volume of 1 liter).

The setting of blow molding (or drawing and blow molding) parameters in order for the containers produced to be correct is a complex operation.

Furthermore, it has been noted that for some markets, the known blow molding or drawing/blow molding methods and devices are not entirely suitable, particularly because of their complexity and cost.

A purpose of the invention is to remedy these disadvantages.

According to the invention, a method of manufacturing a container from plastic material, of the type consisting of thermally conditioning at least certain areas of a preform of the container so that the temperature of said areas exceeds the glass transition temperature of their constituent material, and of injecting a fluid into the preform to cause its expansion in order to form it into a container, is characterized in that it consists of performing a free expansion, that is, outside of a mold, of at least some of the areas of the preform, and of controlling at least one injection parameter of the fluid in order to produce the final container.

The invention is particularly advantageous because it can be implemented without the need for high injection pressures. Thus, tests have made it possible to produce containers with a fluid pressure of less than 10 bars. Also, the invention makes it possible to be free of the need to have expensive compressors; furthermore, it allows the implementation of a machine with light structure, compared to known machines that require a size suitable to the high pressures used.

By heating preforms with a standard heating profile, such as a profile for obtaining bottles on known machines, the method according to the invention allows containers to be obtained that have the general shape of an elongated bubble. Such a general shape, which has limited possibilities of changing shape, is however particularly suitable for containing liquids such as flat water anywhere on earth, particularly in markets where the appearance of the container is not of primary interest.

In one implementation, a limited number of injection parameters is controlled, to obtain containers in elongated bubble shape with a volume that is indeterminate although large enough. However, this is not a problem because in such a case the sale can be made by weight of the filled container.

Moreover, from identical preforms containers of different volumes can be obtained simply by modifying at least one of the fluid injection parameters. This advantage is of particular interest in areas such as emerging markets where it is difficult to provide for the manufacturer or supply of a large variety of preforms.

According to another characteristic, the method consists of controlling at least one injection parameter of the fluid so that the final internal volume of the container falls within predetermined limits with respect to a reference volume.

According to another characteristic the method consists of controlling at least one injection parameter of the fluid by taking into account the temperature of said areas of the preform.

According to other characteristics: one controlled parameter is the pressure of the fluid injected into the preform; one controlled parameter is the flow rate of the fluid injected into the preform.

According to another characteristic, the pressure is variable during injection; in one implementation, it consists of beginning the injection with a pressure that is more than the pressure at the end of injection, and the pressure and initial fluid flow rate are controlled in order to prevent the constituent material of the preform, thus that of the container, from solidifying before obtaining the desired expansion, and the pressure at the end of injection is reduced to prevent the material from bursting.

According to another characteristic, one controlled parameter is the temperature of the fluid.

According to another characteristic, the injection parameters of the fluid are controlled so that expansion is stopped naturally by the solidifying of the constituent material of the preform when the expansion becomes significant, so that when the material is solidified the reaction forces exerted by the material are opposite to those exerted by the fluid; in one variation, the injection parameters of the fluid are controlled so that expansion is naturally stopped by solidifying the constituent material of the preform when the expansion is such that the final internal volume of the container falls within predetermined limits with respect to a reference volume, so that when the material is solidified the reaction forces exerted by the material are opposite to those exerted by the fluid.

According to other characteristics: it consists of stopping the fluid injection after a predetermined time; the fluid is introduced into a compartment prior to its injection and transferred into the preform in order to cause the expansion; the fluid is a gas; because the container is intended to be filled by means of a liquid after it is manufactured, it consists: of first causing the expansion of the preform with a gas, then, while maintaining a residual pressure of gas inside the container when it is formed, of immediately filling the container with a liquid under a gas pressure at least equal to the residual pressure in the container.

According to another characteristic, the fluid is a liquid; in one implementation, because the container is intended to be filled by means of a liquid, it consists of using said liquid to cause the expansion of the preform in order to make it into a container, during the filling phase of the container which thus constitutes its manufacturing phase; in one implementation it consists of introducing into a compartment a volume of liquid corresponding to the desired volume in the container, and of predetermining injection parameters of said liquid to allow all of the liquid contained in said capacity to be introduced into the preform during its expansion in order to produce the final container.

This characteristic is particularly advantageous because the formation and filling of the container are performed in a single step.

According to another characteristic, in order to vary the shape of the containers from one manufacturing to another, the heating profile of said areas of preforms of containers is varied during their thermal conditioning.

Thus, the invention is not limited to obtaining containers having an elementary elongated bubble shape, but to a certain extent it makes it possible to obtain changes in shape around this shape.

Thus, for example, by creating a heating profile with areas that are more or less cool, the movement is promoted of certain areas of the preform during injection of the fluid, which to a certain extent makes it possible to control the shape of the final container. By combining this control of the heating profile with the control of the parameters, it becomes possible to control the shape and volume of the containers.

According to another characteristic, a system of manufacturing containers having a unit for the thermal conditioning of at least some areas of a preform and an expansion unit with at least a device for expanding said preform, which expansion device is associated with a source of fluid to cause the expansion of the preform by injection of said fluid, and has means of sealably isolating the interior of the preform from the exterior environment, and means for placing the interior of the preform in communication with said source of fluid to cause the expansion of the preform, is characterized in that the expansion unit is a free expansion unit for at least certain areas of the preform, and has means for controlling at least one injection parameter of the fluid in order to control the expansion of the preform to produce the final container.

Other characteristics and advantages of the invention will appear from the description of the following figures, which illustrate respectively:

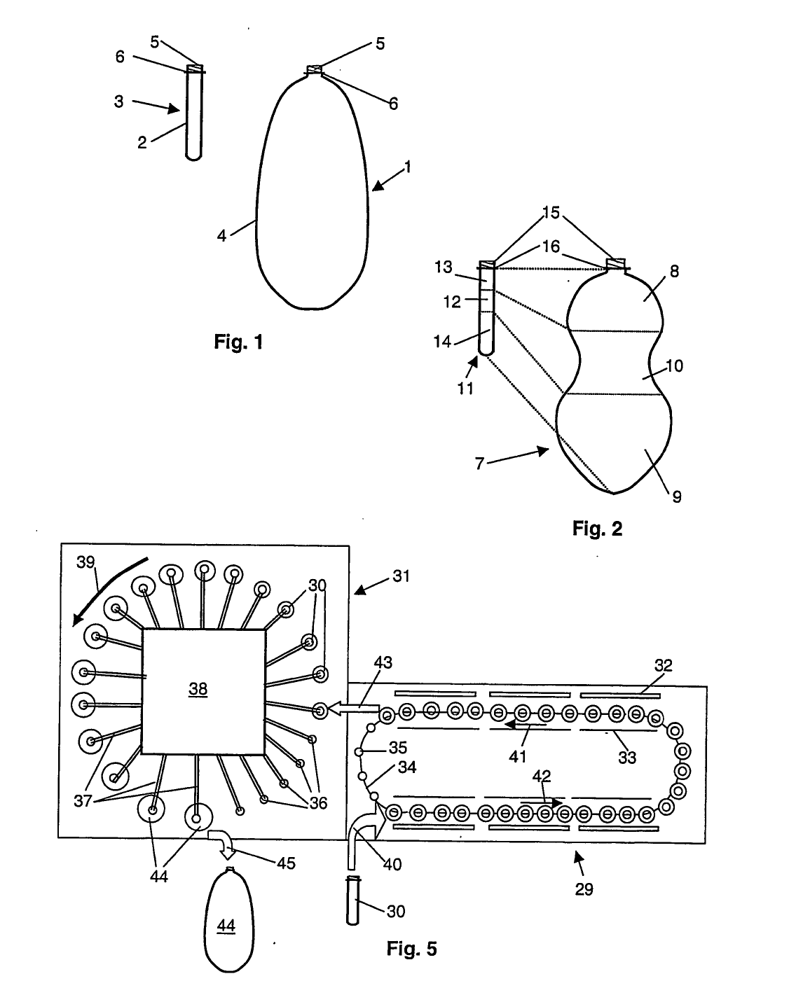

FIG. 1, a front view of a preform that has been relatively homogeneously thermally conditioned and a corresponding container that can be obtained by implementing the method of the invention;

FIG. 2, a view diagrammatically illustrating a preform with a non-homogeneous heating profile and a container that can be obtained by implementing the method of the invention;

FIG. 3, a functional diagram of an associated device for forming the bottom of containers obtained by implementing the invention;

FIG. 4, a functional diagram of a variation of the device of FIG. 3;

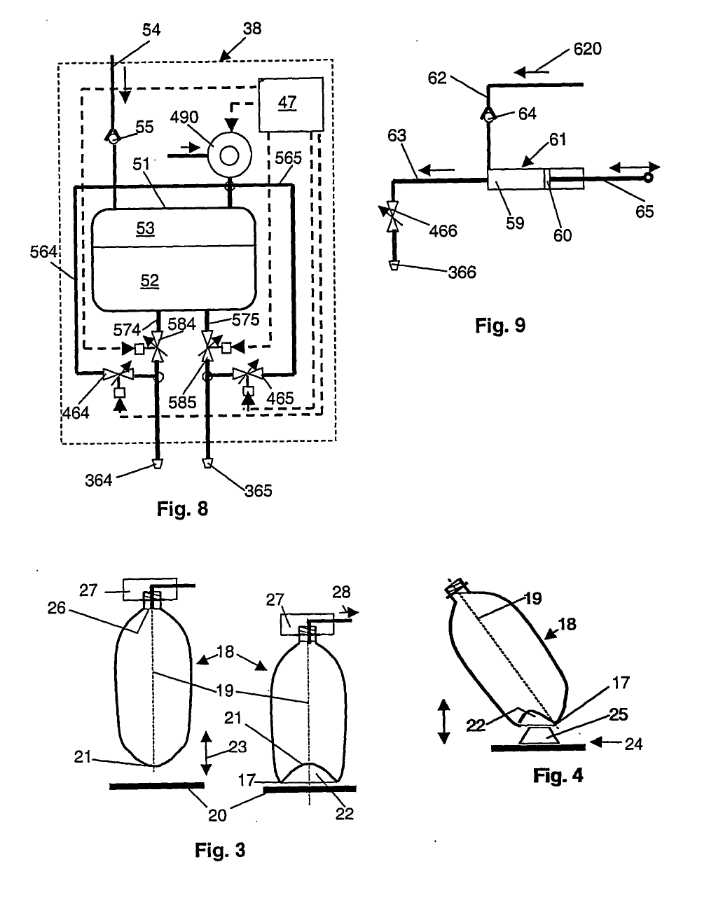

FIG. 5, a functional diagram of a system for manufacturing containers according to the invention;

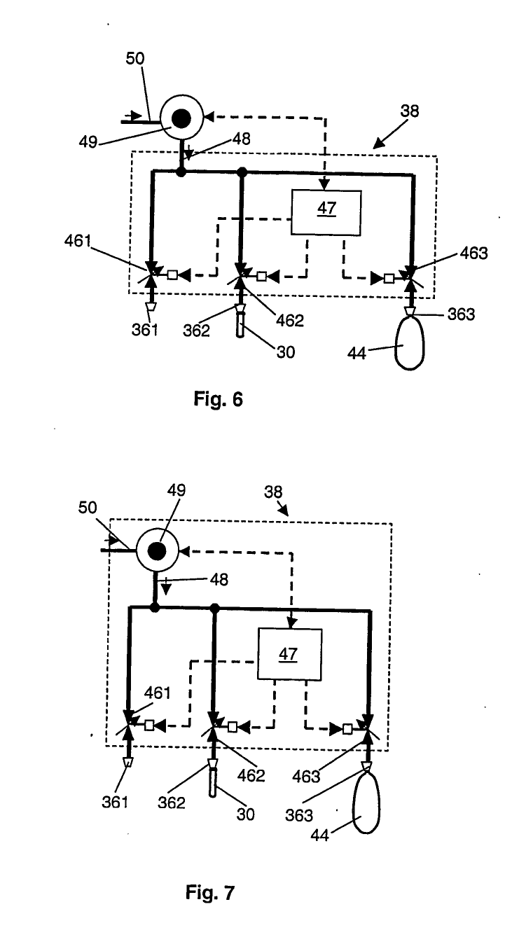

FIGS. 6 to 11, several variations of systems of injecting the fluid that can be contained in the system of FIG. 3.

Represented in FIG. 1 is a first type of container 1 that can be obtained by the invention, by performing a free expansion of the body 2 of a preform 3, thermally conditioned according to a relatively homogeneous heating profile, above the glass transition temperature of the constituent material of the preform 3. For PET, the heating profile should be such that the temperature of the body 2 is around 120° C. Homogeneous profile is understood to mean as being without sharp variation in temperature from one area to another of the body of the preform.

The container 1 of FIG. 1 has a body 4, generally shaped like an elongated bubble, which body 4 of the container 1 is obtained from the constituent material of the body 2 of the preform 3. The container 1 has a neck 5 as well as a collar 6 marking the limit between the neck 5 and the body 4, and in a known way, the neck 5 and the collar 6 of the container 1 are elements that are present on the preform 3 and are not modified during the formation of the container 1. To that end, the neck 5 and the collar 6 of the preform 3 are not heated during the thermal conditioning, or are only very slightly heated.

The method of thermal conditioning used to obtain such a container 1 with a body 4 shaped like an elongated bubble can be perfectly conventional. For example, it can consist of having the preform pass in front of a source of appropriate radiation, such as an assembly of infrared radiation lamps and reflectors, and causing it to rotate around its own longitudinal axis. To that end, a thermal conditioning unit can be used that operates according to the principle explained in FIG. 1 of the above-mentioned document FR-A-2,703,944.

The invention is not limited to the production of containers in the shape of an elongated bubble. Thus, represented in FIG. 2 is a second type of container 7 that can be obtained. The container 7 has a bi-lobed body with three parts, an upper part 8, a lower part 9, and a central part 10 having an average diameter less than that of parts 8, 9, and separating the latter. This container 7 can be obtained by heating different annular areas of a preform 11 differently. One central annular area 12 of the preform 11 is heated to a temperature lower than that of the other upper 13 and lower 14 annular areas. The result is a greater difficulty in drawing the material of the central annular area 12 of the preform 11, so that the container 7 finally has the central part 10 with an average diameter of less than that of parts 8, 9, which central part 10 is composed with the material of the central annular area 12 of the preform 11, and the upper 8 and lower 9 parts of the container are composed respectively of the material of the upper 13 and lower 14 annular areas of the preform 11.

As in the case of FIG. 1, the preform 11 and the container 7 have a neck 15 and a collar 16.

An implementing device for obtaining such a container 7 can include, for heating various areas of the preform differently, a conditioning unit with infrared radiation lamps facing reflectors, such as the one that appears in FIG. 1 of the above-mentioned document FR-A-2,703,944. With such a unit, for heating the central annular areas 12 less than the upper 13 and lower 14 areas of the preform, it is enough simply to apply less power to the lamps facing the area 12 of the preform.

The variation can also be used that is illustrated opposite FIG. 13 of the same document FR-A-2,703,944, that is, using reflectors with non-reflecting areas facing the central annular area 12.

A mode of heating as described above allows containers to be obtained in bi-lobed bubble form in which each section perpendicular to the longitudinal axis of the container is appreciably circular.

Of course, the number of lobes could be greater than two, by suitably adapting the heating profiles.

It is also possible to obtain containers of a shape that is not bi-lobed, but in an elongated bubble shape in which all or part of the sections perpendicular to the longitudinal axis of the containers would not be circular but rather ovoid, for example, by implementing one of the variations of FIGS. 4 to 11 of the document FR-A-2,703,944. Finally, it would also be possible to combine circular sections with non-circular sections and/or incorporate lobes, which themselves can be circular or not, for example by appropriately combining the various modes of thermal conditioning set forth above.

Moreover, it is easy to imagine that by adjusting the fluid injection parameters, it is quite possible to control, to a certain extent, the expansion of the preform and thus the final volume of the container. Among the controllable parameters are the pressure of the fluid, its flow rate, its temperature and the total volume of fluid injected.

In order to control the final volume of the container, the total volume of fluid injected can be controlled differently, depending on whether this fluid is a liquid or a gas. For example, when the fluid is a liquid, a compartment can be filled with a volume of fluid corresponding to the volume of the container to be obtained, and then to empty said compartment into the preform to cause it to expand. It is also possible to inject the liquid directly into the preform while measuring the amount injected, such as by using a flow meter, then stopping the injecting after a time such that the volume injected corresponds to the desired volume. When the liquid is a gas, knowing the pressure, flow rate and injection time allows the volume of the container to be calculated.

However, the conditions in which the preform leaves the conditioning unit must be taken into account. The higher the temperature of its body, the easier it is to expand it. Thus, considering two identical preforms heated according to similar profiles but at different temperatures, and in which a fluid is injected under identical predetermined conditions, they will reach a given volume within different times, the hotter preform being transformed more quickly. As a corollary, for two preforms heated identically, one will be able to reach a given volume before the other, for example if the flow rate and/or pressure and/or temperature of the injected fluid is (are) greater.

It is perfectly comprehensible that the more all of the above-mentioned parameters are taken into account, the closer the final volume of the container will be to a reference volume.

Moreover, in order to predetermine the parameters, it must be taken into account that as the constituent material of the preform expands it tends to cool and solidify, so that the material becomes less and less malleable. The parameters must therefore be adapted so that the material does not solidify before a sufficient volume is reached.

However, from the perspective of distributing the contents “by weight,” the control of the parameters can be simplified. It is quite conceivable to make do with injecting the fluid with a pressure or a specific flow rate while taking into account the temperature of the preform and/or that of the fluid, so that the preform will certainly undergo expansion, and allow the material to solidify naturally. Thus, a container with an acceptable volume will certainly be obtained. It is also conceivable to finalize the parameters so that the final internal volume of the container will certainly fall within a predetermined range with respect to a reference volume, while allowing the material to solidify naturally.

As has already been indicated, the method of the invention makes it possible to obtain containers in the shape of an elongated bubble or containers with lobes, that is, more generally, containers with rounded shapes. Consequently, such containers do not have a base area, such as a bottom, that allows them to stand upright.

However, it is possible to produce a base area on such containers in a step consecutive to their formation, by causing pressure between the area of the container at the location where the base area should be produced and an exterior pressing surface.

Said step can be performed by using either of the devices illustrated by way of examples in FIG. 3 or 4.

In FIG. 3, the base area 17 of a container 18 is centered around the longitudinal axis 19 of the container 18. It is produced by causing the container's end area 21 to press against an element 20, that is, the area that is centered around said longitudinal axis 19 and which has a convexity toward the exterior (visible in the left part of FIG. 3) before the formation of the base area. From the effect of the pressure exerted during the pressing on the element 20, the end area 21 is reversed, as can be seen in the right part of FIG. 3, so that an area 22 with a concavity turned toward the exterior appears at this location, the periphery of said area 22 constituting the base area 17.

The pressure is obtained by causing the container 18 and the element 20 to come together, which is illustrated by the double arrow 23.

In the example illustrated in this FIG. 3, the element 20 has a flat pressing surface.

In the variation of FIG. 4, a base area 17 on a container 18 is obtained by using a device 24 that has a pressing surface with a protrusion 25, to promote the reversal of the container's area where the pressing surface 17 should be produced. Thus, in the example of FIG. 4, the protrusion 25 is in the shape of truncated cone.

Furthermore, as illustrated in FIG. 4, the pressing area 17 can be produced so that it is offset from the longitudinal axis 19 of the container 18.

Of course, it is possible to use either the device of FIG. 3 or that of FIG. 4 to produce the base areas 17 centered around the longitudinal axis 19 of the containers or offset with respect to said longitudinal axis 19 of the container 18.

It should be noted that producing a base area 17 is facilitated when it is carried out on a container that is open, but which is at least partially filled with liquid. The reaction exerted by the weight of the liquid facilitates the reversal and the formation of the base area.

The device 20 or 24 for producing the base areas can be associated with the filling machine of the containers. However, in this case, to avoid losses of liquid during the formation of said areas, the reduction of the internal volume of the container, which occurs during the reversal of the pressing area, should be taken into account.

This can be taken into account in several ways. Thus, in the implementation illustrated in FIG. 3, the container, previously filled to a level 26 that is standard with respect to conventional filling techniques, is held during the formation of the pressing area beneath the fill head 27, which is so designed that, during the formation of the pressing area, the excess liquid resulting from the reduction in internal volume can exit (arrow 28) through the fill head. This implementation is especially interesting because it is independent both of the initial volume (when it is still bubble shaped) as well as the final volume (after formation of the base area) of the container.

In one variation, not shown, the container is initially filled with a smaller volume of liquid, so that it takes into account the reduction in internal volume. In a variation, an excessive free volume is left, then topped off after the formation of the base area.

Other variations, accessible to a person skilled in the art, are conceivable, especially the variation that consists of producing the bottom away from the filling machine.

The functional diagram of a system implementing the invention appears in FIG. 5. In principle, the system is conventional, that is, it has a unit 29 for the thermal conditioning of the preforms 30, associated with a unit 31 for expanding the preforms.

In the example, the thermal conditioning unit 29 is constituted in a known way. It consists of heating elements by means of lamps 32 and reflectors 33, for example constituted in accordance with FIG. 1 of document FR-A-2,703,944, and/or either of its variations of FIGS. 4 to 11, and/or that of FIG. 13. Moreover, preferably the thermal conditioning unit 29 includes means for protecting the neck of the preforms 30 (not shown in the figure) to prevent the heating of the necks. The thermal conditioning unit 29 also includes a driving system 34 for the preforms, such as an endless chain fitted with individual means 35 each of which is suitable for transporting and driving a preform supported by its neck between the lamps and the reflectors. The individual means 35 of the system 34 are also constructed so that, while the preforms 30 are being transported, they are placed in rotation on themselves to allow correct heating of the periphery of their body.

The expansion unit 31 has a fluid injection system with at least a fluid injection head 36, with is connected by a conduit 37 to an assembly 38 to feed the fluid and control its injection. More detailed functional diagrams of different variations of the injection system are represented in FIGS. 6 to 11.

Preferably, as shown in FIG. 5, the expansion unit 31 includes several injection heads 36 that are arranged, for example, on a turning structure (carrousel) represented by the arrow 39, and each of which is connected by a respective conduit 37 to the assembly 38 to feed the fluid and control its injection. This arrangement allows high rates of manufacturing containers to be achieved.

The head, respectively each injection head 36, is constructed so as to be associated with a preform during the step in which the container is being formed, that is, during the injection of the fluid, and to sealably isolate the interior of the preform from the outside environment during this step, in order to prevent the fluid fed by the respective conduit 37 into the preform through the head from escaping to the outside during its injection.

Preferably, means for controlling the temperature of the preforms, such as sensors (not shown) are included in the system in order to provide information relative to this temperature to the assembly 38 for feeding the fluid and controlling its injection, so that, when necessary, said assembly 38 can take this temperature into account in order to control the injection.

The device functions as follows. The preforms 30 are successively introduced (arrow 40) into the thermal conditioning unit 29 where they are grasped individually by a device 35 and are driven in the direction of the arrows 4, 42 around the heating elements 32, 33. At the end of their course in the conditioning unit 29, they are individually discharged, then picked up and transferred (arrow 43) by a transfer device, not shown, to the expansion unit 31.

More specifically, each preform 30 is sealably placed in front of a head 36 of the expansion unit, and fluid is injected under predetermined conditions into the interior in order to form containers 44 which are then discharged (arrow 45) from the system.

The expansion of the preforms has been diagrammatically represented in FIG. 5. A progressive increase in the diameter of the object will be noted (initially preform 30, then container 44) associated with the injection heads 36.

Illustrated in FIGS. 6 and 7 are two variations of a fluid injection system with an assembly 38 for feeding the fluid under pressure and controlling its injection. These two variations, which are only minimally different from each other, each allows the use of gas or liquid as expansion fluid. Moreover, they allow the control of all or part of the parameters (flow rate and/or pressure and/or quantity and/or time and/or temperature of the fluid as compared to that of the preform).

The fluid injection system illustrated in these FIGS. 6 and 7 include three injection heads 361, 362, 363 associated with the assembly 38 for feeding the fluid and controlling its injection. It is understood, of course, that the number of heads could be different.

Each head 361, 362, 363 is associated with a respective valve 461, 462, 463 for remotely opening and closing (such as electrical or pneumatic control). The remote control of the valves is accomplished from a unit 47 that controls the operation of the injection system. In the example, this unit 47 is represented as an integral part of the assembly 38 for feeding the fluid and controlling its injection. Each valve can be controlled as all-or-nothing (only one flow rate) or proportional (variable flow rate).

Each valve 461, 462, 463 is also inserted between its respective associated head 361, 362, 363 and a conduit 48 for feeding the pressurized fluid. The three assemblies, each composed of a valve and the respective associated head, are therefore mounted in parallel on the conduit 48, so that when a valve is opened, in response to the appropriate command from the control unit 47, fluid can circulate toward the respective associated head.

In the example illustrated, one head 361 is free, while a preform 30 is placed under the head 362, ready to be transformed into a container, and a formed container 44 is under the head 363, ready to be removed.

The difference between the variations of FIGS. 6 and 7 is in the fact that, in the system of FIG. 6, the fluid is pressurized outside the assembly 38 (such as at one side or at some distance from the expansion unit 31 of FIG. 5) and the conduit 48 for carrying the pressurized fluid enters the assembly 38, while in the system of FIG. 7, the fluid is pressurized inside the assembly 38 (such as inside the expansion unit 31 of FIG. 5) and the conduit 48 for carrying pressurized fluid is inside the assembly 38.

The pressurization is accomplished by a device 49 appropriate for the fluid used (compressor, booster, pump, etc.), which device 49 is preferably connected to the control unit 47, thus enabling the pressure and/or flow rate exiting this device 49 to be acted on. In the example of FIG. 6, the pressurization device 49, outside the assembly 38, is fed by a conduit 50, also outside, and forces the fluid to the conduit 48. In the example of FIG. 7, the pressurization device 49 is inside the assembly 38; it forces the fluid to the conduit 48 and is fed by a conduit 50 entering the assembly 38.

The variations of FIGS. 6 and 7 make it possible to use the liquid that will be the final contents of the container as the fluid to cause the expansion. In particular, the use of a fluid is especially feasible in the case of a process for hot-filling containers (temperature near the glass transition temperature of the preform material), since the temperature of the liquid prevents the material from solidifying too quickly.

These variations also allow gas, such as compressed air, to be used for the expansion in the unit 31, and to transfer the containers after expansion to a filler for flat beverages. Alternatively, additional respective conduits can be provided, leading to each head, and the fluid carrying circuits (expansion gas and fill liquid) can be arranged so that after expansion the fill liquid can be directly fed into the containers held under the expansion heads that also serve for filling. However, if the liquid is fed at atmospheric pressure (gravity fill), the containers must first be degassed to equalize the pressure in the container with the exterior. Otherwise filling remains impossible as long as the pressure in the container exceeds atmospheric pressure. Wait for the material to solidify, while holding the container under pressure for sufficient time. Indeed, if the container is degassed too quickly, before the material has solidified, there is a risk that the material will retract, reducing the volume. This type of cycle of formation and filling is therefore long.

FIG. 8 shows an arrangement that allows preforms to be expanded with a gas and the containers to be filled immediately after expansion, without waiting for the material to solidify, so that the cycle of formation and filling of a container can be optimized. This arrangement includes means for causing the expansion of the preform by means of a gas, means for maintaining a residual pressure of gas inside the container when it is formed, and means for filling the container immediately with a liquid under pressure from gas at least equal to the residual pressure in the container. Thus, holding a residual pressure in the container prevents a retraction of the material. Placing the liquid under pressure from gas at least equal (therefore greater than or equal to) the residual pressure in the container makes gravity filling possible, since the internal pressure of the container does not resist the entry of the liquid.

Advantageously, the layout of FIG. 8 uses the principle and arrangements implemented in fillers for gaseous or carbonated beverages, profitably using the gasification or carbonation phase of the container, prior to filling it, to cause its expansion.

To that end, the injection system of FIG. 8, illustrated in the example for the distribution of fluid to two heads 364, 365, comprises an assembly 38 for carrying fluid under pressure and controlling its injection, a tank 51 containing the liquid 52 over which there is a free space 53 with gas under pressure. The gas can be compressed air or any other gas, particularly a gas that can be used to condition the liquid (carbon dioxide when the liquid would be a carbonated beverage, for example). The free space 53 at the top of the tank 51 is in communication with an appropriate device 490 for pressurizing and/or keeping under pressure the gas inside this free space 53. Depending on the case, the device 490 can be a compressor or a device to carry the gas that can be used to condition the liquid.

The liquid 52 is carried into the tank 51 through a conduit 54 provided with a non-return mechanism 55, to keep the gas under pressure in the tank from escaping.

To feed the gas contained in the free space 53 at the top of the tank 51 to the heads 364, 365, this free space 53 is in communication with the heads 364, 365 through respective conduits 564, 565, in each of which is inserted a remote controlled opening and closing valve 464, 465. The remote controlling of the valves is accomplished from a unit 47 that controls the operation of the injection system. Each valve can be controlled as all-or-nothing (single flow rate) or proportional (variable flow rate).

Thus, by opening the valve associated with a head, the gas contained in the free space 53 at the top of the tank 51 is directed toward the corresponding head.

To feed the liquid to the containers, the bottom of the tank 51 is connected with the heads 364, 365, by means of the respective conduits 574, 575 in each of which, another valve 584, 585 is inserted to remotely command the opening and closing. These valves may also be single flow rate or variable flow rate.

Thus, by opening the valve associated with a head, liquid contained in the tank is directed to the corresponding head.

The command to open and close the valves 464, 465 that allow gas to flow to the heads, as well as valves 584, 585 that allow liquid to flow, is provided by the unit 47 to control the operation of the injection system. The control unit is connected to the appropriate device 490 to pressurize the gas inside the free space 53 of the tank 51, and/or to maintain it under pressure.

This device functions as follows.

When there is no preform present under the heads 364, 365, the valves 464, 465 that allow gas to flow into the heads and valves 584, 585 that allow liquid to flow are placed in the closed position by the unit 47 that controls the operation of the injection system. After a thermally conditioned preform has been placed under a head 364, the corresponding gas supply valve 464 is opened by the control unit 47, and the expansion of the preform results. Then, when the expansion is completed, the valve 564 corresponding to flow of the liquid is opened, so that the liquid flows by gravity into the container.

In a known way, the filling should be accompanied by an evacuation of the gas contained in the container. However, to prevent a retraction of the material, particularly at the beginning of the filling phase, the evacuation must be produced without the pressure in the container decreasing too much; also, when the liquid should preserve a certain pressure (gaseous or carbonated beverage), the pressure in the container should not decrease too much during the evacuation accompanying the filling. Furthermore, it is preferable that the evacuation not disturb the inflow of liquid, and that it be performed by a circuit other than that of the liquid feed circuit.

To that end, in one implementation, the evacuation is carried out directly toward the tank by the air supply circuit itself, so that the overall pressure of the fluid circuit incorporating the tank and the container do not change during the filling, and only transfers of fluid (gas, then liquid) are done at constant pressure, which makes it possible to maintain a suitable gas pressure in the container, if necessary. In this case, when the liquid feed valve 584 is opened, the gas supply valve 464 is not closed again by the control unit 47, and the two valves are only closed again after filling is complete.

In one variation, not shown, the evacuation is carried out directly to the tank, although by a dedicated circuit, which can include means for filtering the gas.

It is conceivable, however, to begin the filling by evacuating the gas to the tank and complete it by exhausting the gas to the exterior (return to atmospheric pressure) to reduce the length of the fill cycle still more. In effect, when the fill liquid is fed at a temperature below the glass transition temperature of the constituent material of the container, this contributes to solidifying the material when it enters the container. Consequently, after the filling has begun and the material has become solidified, it becomes possible to reduce the pressure in the container to the level of the exterior pressure. However, this is only conceivable with flat liquids (water or others) that do not need to maintain a gas pressure after filling.

It can easily be understood that with the arrangements described with reference to FIGS. 6 to 8, to control the final volume of a container more or less precisely, the control unit 47 must control more or less precisely the following injection parameters for the fluid (gas or liquid) used to cause the expansion, while also taking into account the temperature of the preform when it is placed beneath a head (or the temperature of the preform at the conditioning unit 29 seen in FIG. 5): temperature of the fluid and/or injection pressure and/or flow rate and/or duration of injection. For example, at identical injection pressures and flow rates, two preforms heated identically will not reach the same volume in the same amount of time if the fluid injected into one of them is at a different temperature than the fluid injected into the other; moreover, at identical injection pressures and flow rates and temperatures, two preforms heated differently will not reach the same volume in the same amount of time; in some cases it will even be impossible for the two preforms to reach the same volume, because the material of one can solidify during injection. It is necessary, therefore, for appropriate sensors to be placed in the system. To that end, depending on the number of parameters that are to be controlled, the unit 47 for controlling the devices of FIGS. 6 to 8 will be able to incorporate devices (not shown) that allow this unit to control all or part of the various parameters mentioned (flow rate, pressure, temperature of the preforms and/or of the fluid, duration) used during the injection.

However, in order to facilitate the control operations, in a preferred implementation of the invention the device of FIG. 9 is used, which makes it possible to reduce the number of parameters to be controlled, and which can also be used to produce containers of different volumes.

This device has a cylinder 59/piston 60 assembly, which determines a chamber having a compartment 61 of variable capacity, depending on the position of the piston 60 in the cylinder 59. Said space is connected by a conduit 62 to a source of fluid, not shown.

A second conduit 63 connects the compartment to a fluid injection head 366. A valve 466 for remotely opening and closing is installed in this conduit between the head 366 and the compartment.

A non-return valve 64 is placed in the conduit 62 between the fluid source and the compartment.

The device functions as follows: the piston 60 is placed in a specific position in the cylinder 59 so that the compartment 61 has an initial volume; the fluid (liquid or gas) is then introduced (arrow 620) into the compartment 61 through the conduit 62 in order to fill it; the valve 466 is opened and the piston 60 is pushed by its rod 65 so as to reduce the volume of the compartment and inject the fluid toward the head 366. The non-return valve 64 prevents the return of the fluid to the source.

It can easily be understood that, if the fluid used is not compressible (such as a liquid), and the piston's drive speed is selected so that the whole volume of fluid can be forced out before the material solidifies, which drive speed is determined by adjusting the equipment, then the volume of the container is predetermined by the initial volume of the compartment. Therefore, it is possible to produce series of containers of identical volumes, or containers each with a predetermined volume.

It can also be seen that if the fluid is compressible and the drive speed of the piston is selected so that the whole volume of fluid can be forced out before the material solidifies, the final volume of the container will depend not only on the initial volume of the compartment, but also on the initial pressure and temperatures of the fluid and of the constituent material of the preform. These various parameters must therefore be taken into account in order to endeavor to predetermine the final volume of the containers.

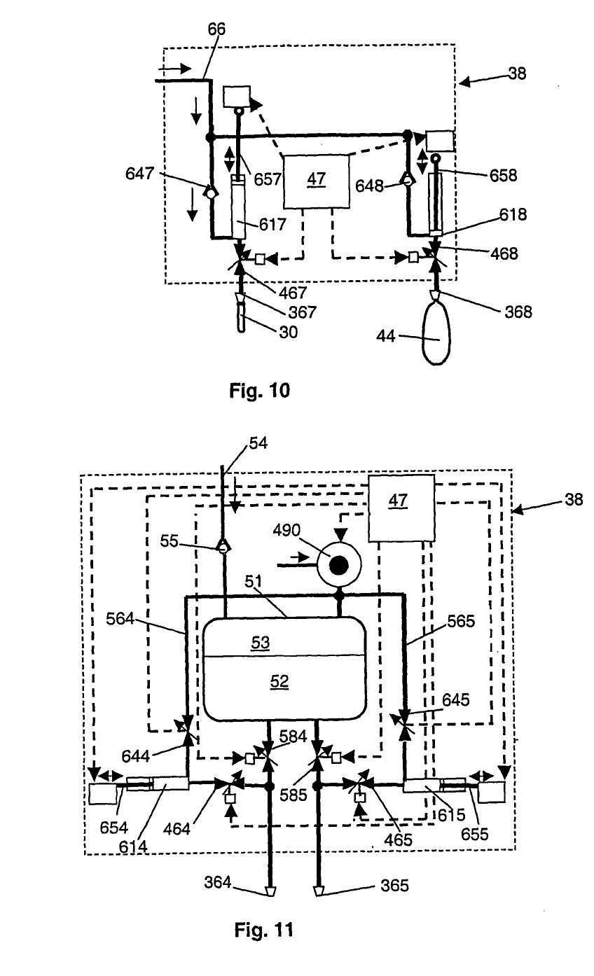

Illustrated in FIG. 10 is a first variation of implementation of the device of FIG. 9, a fluid injection system with an assembly 38 for feeding the pressurized fluid and controlling its injection. The system, shown here for feeding two heads 367, 368, has a conduit 66 for feeding the fluid in the assembly 38, two devices like the one in FIG. 9, which are connected in parallel to the conduit 66, and a control unit 47 for controlling the system.

Thus, each device like the one in FIG. 9 has a non-return valve 647, 648 between the conduit 66 and its respective compartment 617, 618, and inserted between the head 367, 368 and the respective compartment 617, 618 is a valve 467, 468 to remotely control the opening and closing.

The control unit 47 makes it possible to control the valves 467, 468 and the devices 657, 658 for driving the piston rods associated with each compartment, in order to obtain suitable flow rates and/or pressures, while taking into account, when appropriate, the temperature of the fluid and the temperature of the preforms by means of appropriate sensors, not shown.

The device of FIG. 10 can use either gas or liquid as injection fluid.

Illustrated in FIG. 11 is an improved variation of the invention, which uses the device of FIG. 9 in a system similar to the one in FIG. 8, so that the same elements have the same reference numbers.

The only differences between the arrangements of the systems of FIGS. 8 and 11 are: first, in each of the conduits 564, 565 connecting the free space 53 at the top of the tank 51 to the heads 364, 365, upstream from the valve 464, 465 for remotely controlling the opening and closing, a respective compartment 614, 615 composed of a cylinder-piston assembly, has been inserted; moreover, another valve 644, 645 for remotely controlling the opening and closing is positioned upstream of the respective compartment, and therefore between the free space 53 at the top of the tank 51 and the respective compartment, which valve 644, 645 replaces the non-return valve of FIG. 9.

The remote control of the assembly of valves is connected to a unit 47 for controlling the operation of the injection system, as well as the devices 654, 655 for driving the piston rods associated with each compartment.

Such an arrangement allows high production to be achieved, since each compartment 614, 615 is initially filled with an initial volume of gas under pressure, corresponding to the volume of gas contained in the free space 53 at the top of the tank 51, and the displacement of the piston to transfer the gas to the respective associated head 364, 365 increases the pressure.

For example, the operation of the system to feed the head 364 is as follows:
initially, at least the liquid feed valves 584, 585 and air feed valves 464, 465 are placed in the closed position by the control unit 47;
the piston is positioned in the chamber to determine a compartment 614 of predetermined capacity (taking into account the temperatures of the fluid and/or of the material, and of the desired final volume);
and the gas contained in the free space 53 at the top of the tank 51, enters the compartment 614 through the valve 644, which is open;
this valve 644 is closed again; the corresponding valve 464 inserted between the 614 and the head 364 is opened and the piston is thrust (actuator 654) so as to reduce the volume of the compartment and force the fluid into the container to cause it to expand.

When the expansion, is complete, the corresponding liquid feed valve 584 is opened so that the liquid flows by gravity into the container.

The fill cycle corresponds to the one of FIG. 8.

As mentioned with regard to FIG. 8, the filling should be accompanied by an evacuation of the gas contained in the container without the pressure in the container dropping too much and without disturbing the feed of the liquid.

As in the case of FIG. 8, the evacuation can be done directly toward the tank through the air feed circuit itself, so that the overall pressure of the fluid circuit incorporating the tank and the container does not change during filling. To allow this, when the liquid feed valve 584 is opened, not only is the gas feed valve 464 closed again by the control unit 47, but the valve 644 upstream of the compartment is opened again to allow the gas to leave toward the free space 53 at the top of the tank 51.

After completion of the filling, the fill valve 584 is closed, as well as the valve 464 located between the compartment 614 and the head 364. The piston is again positioned in the chamber to determine a compartment 614 of predetermined volume, which compartment is filled with gas from the free space 53 at the top of the tank 51, and the cycle begins again.

It can easily be seen that with all of the illustrated variations, it is perfectly possible to control the flow and/or the pressure of the injected fluid either by appropriately controlling the devices for pressurizing the fluid used, corresponding to the devices 49 (visible in FIGS. 6 and 7), 490 (visible in FIGS. 8 and 10), or by moving more or less quickly, by means of their drive devices, the piston rods 65, 654, 656, 657, 658 (visible in FIGS. 9, 10, 11) associated with the compartments, either by appropriately controlling the device 490 for pressurizing the fluid used, visible in FIG. 10, and by moving more or less quickly, by means of their drive devices, the piston rods 654, 655 (visible in FIG. 11) associated with the respective compartments 614, 615.

Thus, it is particularly advantageous to begin the injection with a greater flow rate and/or pressure than at the end of injection, and to control the initial pressure and/or flow rate of fluid to prevent the constituent material of the preform, and thus of the container, from solidifying before obtaining the desired expansion, and to reduce the pressure and thus the flow rate at the end of injection to prevent the material from bursting.

Of course, the invention is not limited to the forms of embodiment described and specifically claimed; it includes all equivalents accessible to a person skilled in the art.

1. Method of manufacturing a container from plastic material, comprising: thermally conditioning at least certain areas of a preform of the container so that the temperature of said areas exceeds the glass transition temperature of their constituent material, injecting a fluid into the preform to cause its expansion in order to form it into a container, performing a free expansion, outside of a mold, of at least some of the areas of the preform, and controlling at least one injection parameter of the fluid in order to produce the final container.

2. Method according to claim 1, wherein it comprises controlling at least one injection parameter of the fluid so that the final internal volume of the container falls within predetermined limits with respect to a reference volume.

3. Method according to claim 1, wherein it comprises controlling at least one injection parameter of the fluid by taking into account the temperature of said areas of the preform.

4. Method according to claim 1, wherein one controlled parameter is the pressure of the fluid injected into the preform.

5. Method according to claim 1, wherein one controlled parameter is the flow rate of the fluid injected into the preform.

6. Method according to claim 4, wherein the pressure is variable during injection.

7. Method according to claim 6, wherein it comprises beginning the injection with a flow rate and/or a pressure that is more than the pressure at the end of injection, and in that the flow rate and/or the pressure and initial fluid flow rate are controlled in order to prevent the constituent material of the preform, thus that of the container, from solidifying before obtaining the desired expansion, and the pressure at the end of injection is reduced to prevent the material from bursting.

8. Method according to claim 1, wherein one controlled parameter is the temperature of the fluid.

9. Method according to claim 1, wherein it comprises controlling the injection parameters of the fluid so that expansion is stopped naturally by the solidifying of the constituent material of the preform when the expansion becomes significant, so that when the material is solidified the reaction forces exerted by the material are opposite to those exerted by the fluid.

10. Method according to claim 2, wherein it comprises controlling the injection parameters of the fluid so that expansion is naturally stopped by solidifying the constituent material of the preform when the expansion is such that the final internal volume of the container falls within predetermined limits with respect to a reference volume, so that when the material is solidified the reaction forces exerted by the material are opposite to those exerted by the fluid.

11. Method according to claim 1, wherein it comprises stopping the fluid injection after a predetermined time.

12. Method according to claim 1, wherein the fluid is a gas.

13. Method according to claim 12, wherein, because the container is intended to be filled by means of a liquid after it is manufactured, it comprises:
first causing the expansion of the preform;
then, while maintaining a residual pressure of gas inside the container when it is formed, immediately filling the container with a liquid under a gas pressure at least equal to the residual pressure in the container.

14. Method according to claim 13, wherein it comprises first sealably isolating the interior of the preform from the exterior environment; placing the interior of the preform in communication with a source of gas for pressurizing the fill liquid, in order to cause the expansion of the preform by means of said source; then, when the expansion is completed, while maintaining the isolation from the exterior and the communication between the interior of the preform with the source of gas, of causing the filling of the container thus formed with the liquid under pressure.

15. Method according to claim 12, wherein the gas is compressed air.

16. Method according to claim 1, wherein the fluid is a liquid.

17. Method according to claim 16, wherein, because the container is intended to be filled by means of a liquid, it comprises using said liquid to cause the expansion of the preform in order to make it into a container, during the filling phase of the container which thus constitutes its manufacturing phase.

18. Method according to claim 17, wherein the liquid is hot.

19. Method according to claim 1, wherein it comprises introducing a predetermined volume of fluid into a compartment, placing the compartment in sealed communication with the preform, and transferring the fluid from the compartment to the preform, while controlling at least one transfer parameter of said fluid outside the compartment to allow the expansion of the preform and its transformation into a container.

20. Method according to claim 1, wherein, to vary the shape of the containers from one manufacturing to another, it comprises modifying the heating profile of said areas of preforms of containers during their thermal conditioning.

21. Method according to claim 1, wherein it includes the step of producing a base area on the container, in a step consecutive to their formation, by causing pressure between the area of the container at the location where the base area should be produced and an exterior pressing surface.

22. System of manufacturing containers comprising a unit for thermally conditioning at least a preform and an expansion unit with at least an expansion device of the said at least a preform, which expansion devices is associated with a source of fluid to cause the expansion of the preform by injection of said fluid, and it has means for sealably isolating the interior of the preform from the exterior environment, and means for placing the interior of the preform in communication with said source of fluid to cause the expansion of the preform, characterized in that the expansion unit is a free expansion unit of at least certain of said areas of the preform, and that it has a control unit for controlling at least one injection parameter of the fluid in order to control the expansion of the preform produce the final container.

23. System according to claim 22, wherein it has the control unit is associated with means for measuring a temperature of at least one area of the preform, and the means for controlling at least one injection parameter of the fluid are devised so as to effect this control as a function of the result of the temperature measurement of the preform.

24. System according to claim 22, wherein the control unit is associated with means for controlling the pressure of the fluid injected into the preform.

25. System according to claim 24, wherein the means for controlling the pressure of the fluid injected into the preform are devised to vary the pressure of the fluid during the injection.

26. System according to claim 22, wherein the control unit is associated with means for controlling the flow rate of the fluid injected into the preform.

27. System according to claim 22, wherein the control unit is associated with means for controlling the temperature of the fluid.

28. System according to claim 22, wherein the control unit is associated with means for controlling the duration of injection of the fluid.

29. System according to claim 22, wherein, because the container is intended to be filled with a liquid after it is manufactured, and the fluid used for the expansion is a gas, it includes means for maintaining a residual pressure of gas inside the container when it is formed, and for immediately filling the container with a liquid under pressure of gas at least equal to the residual pressure in the container.

30. System according to claim 29, wherein it includes a tank of pressurized fill liquid, a source of gas for pressurizing the tank, and means for placing the interior of the preform in communication with said source of pressurized gas, in order to cause the expansion of the preform by means of said source, and means, when the expansion is complete, of maintaining isolation from the exterior and communication between the interior of the preform and the source of gas, and causing the filling of the container thus formed.

31. System according to claim 22, wherein, because the container is intended to be filled with a liquid from a filling unit, the expansion unit is composed of the filling unit and the control unit is associated with means for controlling the pressure of the fill liquid.

32. System according to claim 22, wherein the source of fluid for causing the expansion is composed of a compartment containing a volume of fluid at least equal to the desired volume for the final container, and a control unit is associated with means for transferring the fluid contained in the compartment to the preform and means for controlling at least one transfer parameter of said fluid outside the compartment in order to allow the final container to have a predetermined volume.

33. System according to claim 22, wherein the thermal conditioning unit has means for preselecting the heating profile the profile of the preform.
